(19) United States
(12) Patent Application Publication
(10) Pub. No.: US 2025/0320616 A1
(43) Pub. Date: Oct. 16, 2025

(54) DIFFERENTIAL PRESSURE ELECTROLYSIS DEVICE

(71) Applicant: HONDA MOTOR CO., LTD., TOKYO (JP)

(72) Inventors: Shinsuke CHOKYU, WAKO-SHI (JP); Yohei KATAOKA, WAKO-SHI (JP); Kento KUSATSUGU, WAKO-SHI (JP); Wataru KASHI, WAKO-SHI (JP)

(21) Appl. No.: 19/170,220

(22) Filed: Apr. 4, 2025

(30) Foreign Application Priority Data
Apr. 10, 2024 (JP) 2024-063100

(51) Int. Cl. C25B 13/02; C25B 9/23; C25B 9/77; C25B 13/08

(52) U.S. Cl. CPC C25B 13/02; C25B 9/23; C25B 9/77; C25B 13/08

(57) ABSTRACT

A differential pressure electrolysis device is equipped with a resin frame member bonded to a peripheral edge portion of an electrolyte membrane. A first member is interposed between a first separator and the resin frame member, and a second member is interposed between the resin frame member and a second separator. The differential pressure electrolysis device is equipped with a positioning member. The positioning member positions the resin frame member relative to the first member or the second member. However, the positioning member permits the resin frame member to move along a surface direction.

### CROSS-REFERENCE TO RELATED APPLICATIONS

This application is based upon and claims the benefit of priority from Japanese Patent Application No. 2024-063100 filed on Apr. 10, 2024, the contents of which are incorporated herein by reference.

### BACKGROUND OF THE INVENTION

### Field of the Invention

The present disclosure relates to a differential pressure electrolysis device that obtains a high pressure gas by way of electrolysis.

### Description of the Related Art

As one example of a differential pressure electrolysis device, there is known a differential pressure water electrolysis device that electrolyzes water and thereby obtains hydrogen and oxygen (for example, refer to JP 2019-157213 A). As another example of such a pressure differential electrolysis device, there may be cited an electrochemical hydrogen compressor that electrolyzes low pressure hydrogen at one electrode, and generates high pressure hydrogen at the other electrode. Such a differential pressure electrolysis device is equipped with an electrolysis cell. The electrolysis cell includes a membrane electrode assembly, and a first separator and a second separator that sandwich the membrane electrode assembly therebetween. The membrane electrode assembly includes a first electrode, a second electrode, and an electrolyte membrane that is interposed between the first electrode and the second electrode. The first electrode is one of an anode or a cathode, and the second electrode is the other of the anode or the cathode.

In the case that the electrolyte membrane is a proton conductor, and further, water is supplied to the anode, electrons, protons, and oxygen are generated at the anode, and hydrogen is generated at the cathode. The hydrogen is higher in pressure in comparison with the oxygen. A similar reaction takes place also in the case that water is supplied to the cathode; however, the oxygen is at a higher pressure than the hydrogen. In contrast to this feature, in the case that the electrolyte membrane is an anion conductor, and further, the water is supplied to the cathode, hydrogen and hydroxide ions are generated at the cathode, and oxygen and electrons are generated at the anode. The oxygen is higher in pressure in comparison with the hydrogen. A similar reaction takes place also in the case that water is supplied to the anode; however the hydrogen is at a higher pressure than the oxygen. In this manner, in the differential pressure water electrolysis device, the pressure of the gas generated at one of the electrodes is greater in pressure than the pressure of the gas generated at the other of the electrodes.

### SUMMARY OF THE INVENTION

The electrolyte membrane includes a first surface that faces toward the first electrode, and a second surface that faces toward the second electrode. In the case that a high pressure gas is generated in the second electrode, the second surface receives the pressure from the gas. Due to such a cause, a concern arises in that wrinkles occur (deformation occurs) in the electrolyte membrane. Further, in the fuel cell, although a configuration is widely known in which an electrolyte membrane is bonded to a resin frame member, in the case that such a configuration is applied to the differential pressure electrolysis device, another concern arises in that the electrolyte membrane may peel off from the resin frame member at a time when the electrolyte membrane undergoes swelling.

The present disclosure has the object of solving the aforementioned problem.

An aspect of the present disclosure is characterized by a differential pressure electrolysis device equipped with an electrolysis cell including a membrane electrode assembly in which an electrolyte membrane is interposed between a first electrode and a second electrode, and a first separator and a second separator configured to sandwich the membrane electrode assembly between the first separator and the second separator. In the differential pressure electrolysis device, in the second electrode, a gas whose pressure is higher than a pressure of a gas obtained at the first electrode is obtained.

The differential pressure electrolysis device includes a resin frame member bonded to a peripheral edge portion of the electrolyte membrane, a first member interposed between the first separator and the resin frame member in a stacking direction of the first electrode, the electrolyte membrane, and the second electrode, a second member interposed between the resin frame member and the second separator in the stacking direction, and a positioning member configured to position the resin frame member with respect to the first member or the second member in a surface direction perpendicular to the stacking direction. The positioning member permits the resin frame member to move along the surface direction.

When the electrolyte membrane undergoes expansion along the surface direction, the resin frame member moves along the surface direction. In accordance with this feature, a situation is avoided in which wrinkles are generated in the electrolyte membrane which has received the pressure of the gas.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a schematic overall perspective view of a differential pressure electrolysis device (a water electrolysis device) according to one embodiment of the present disclosure;

FIG. 2 is a schematic cross-sectional view as viewed from a diametrical direction of an electrolysis cell constituting the water electrolysis device;

FIG. 3 is a cross-sectional view of principal components of the electrolysis cell as viewed from a diametrical direction thereof;

FIG. 4 is a schematic plan view of a framed structural body as viewed from above in a stacking direction;

FIG. 5 is a schematic plan view of a framed structural body of another aspect of the disclosure as viewed from above in the stacking direction;

FIG. 6 is a cross-sectional view of principal components of an electrolysis cell of a water electrolysis device according to a second embodiment as viewed from a diametrical direction thereof;

FIG. 7 is a cross-sectional view of principal components of an electrolysis cell of a water electrolysis device according to a third embodiment as viewed from a diametrical direction thereof;

FIG. 8 is a cross-sectional view of principal components of an electrolysis cell of a water electrolysis device according to a fourth embodiment as viewed from a diametrical direction;

FIG. 9 is a cross-sectional view of principal components of an electrolysis cell of a water electrolysis device according to a first exemplary modification of the fourth embodiment as viewed from a diametrical direction thereof; and

FIG. 10 is a cross-sectional view of principal components of an electrolysis cell of a water electrolysis device according to a second exemplary modification of the fourth embodiment as viewed from a diametrical direction thereof.

### DETAILED DESCRIPTION OF THE INVENTION

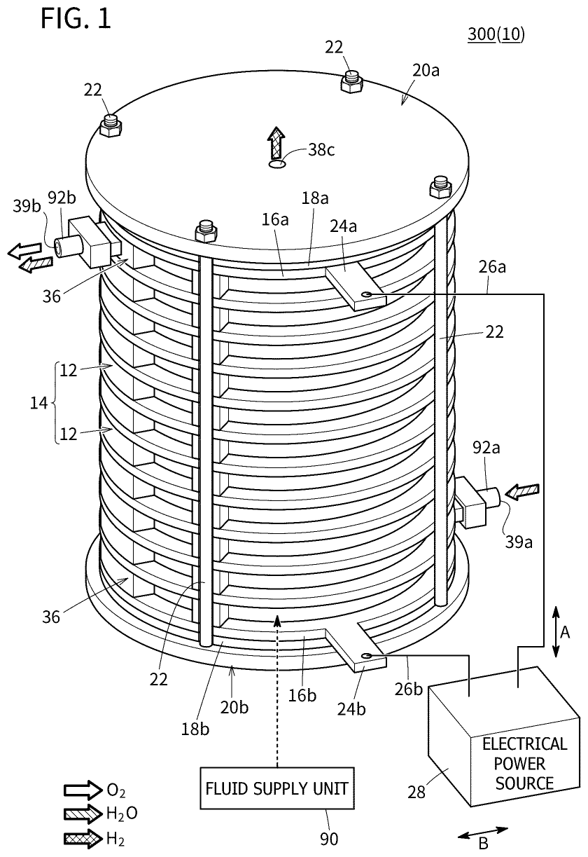

Hereinafter, a description will be given concerning an example of a case in which electrolysis cells 12, as shown in FIG. 1, are stacked in the vertical direction (the direction of the arrow A). Accordingly, the terms “upper” and “lower” respectively imply an upper direction and a lower direction in the stacking direction. However, these directions are provided for the sake of convenience in order to simplify the description. The stacking direction of a differential pressure electrolysis device 300 is not necessarily limited to being a vertical direction. The stacking direction of the electrolysis cells 12 may be a horizontal direction (the direction of the arrow B) that is perpendicular to the vertical direction.

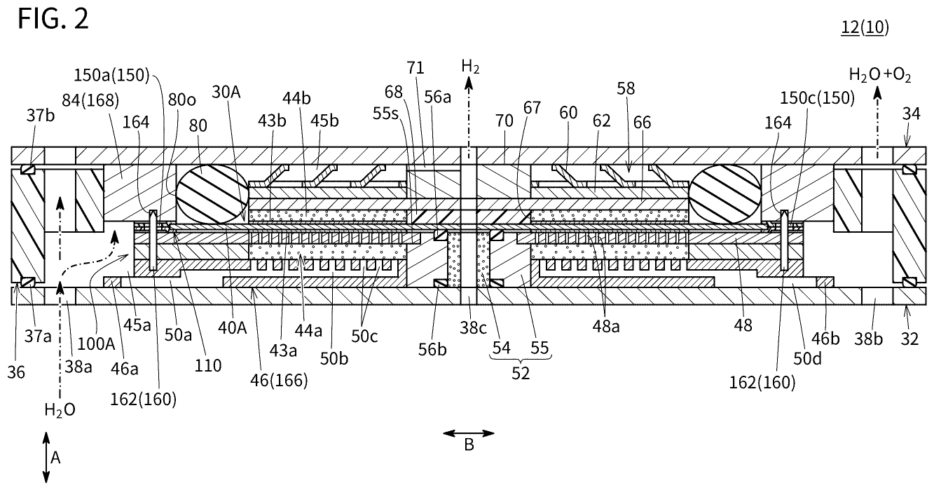

FIG. 1 is a schematic perspective view of the differential pressure electrolysis device 300. In the first embodiment, the differential pressure electrolysis device 300 is a water electrolysis device 10 that electrolyzes water. Therefore, in the first embodiment, a description will be given in detail concerning the water electrolysis device 10. The same applies to the second embodiment to the fourth embodiment which will be described later. However, insofar as it is a device that generates gas in a second electrode 43b as shown in FIG. 2, the differential pressure electrolysis device 300 is not necessarily limited to being the water electrolysis device 10.

In the water electrolysis device 10, as a result of the water undergoing electrolysis, a first gas is generated at a first electrode 43a, and further, a second gas is generated at the second electrode 43b shown in FIG. 2. The second gas is higher in pressure than the first gas. In the present specification, the second electrode 43b refers to an electrode for the purpose of obtaining a high pressure gas. For the sake of simplicity and ease of understanding, in the first embodiment, an example is illustrated in which oxygen is generated as the first gas at the first electrode 43a, and hydrogen is generated as the second gas at the second electrode 43b. In this aspect, the first electrode 43a is an anode where an oxidation reaction takes place, and the second electrode 43b is a cathode where a reduction reaction takes place. An electrolyte membrane 40A is a proton exchange membrane through which protons are capable of moving, and for example, is a hydrocarbon (HC)-based polymer membrane or a fluorine-based polymer membrane.

The water electrolysis device 10 is equipped with the electrolysis cells 12. As shown in FIG. 1, in the water electrolysis device 10, a stacked body 14 is formed by stacking a plurality of the electrolysis cells 12. At one end (an upper end) in the stacking direction of the stacked body 14, from a downward direction toward an upward direction, a terminal plate 16a, an insulating plate 18a, and an end plate 20a are arranged. At another end (a lower end) in the stacking direction of the stacked body 14, from the upward direction toward the downward direction, a terminal plate 16b, an insulating plate 18b, and an end plate 20b are arranged.

The electrolysis cells 12 have a substantially circular shape when viewed in plan. In this case, the surface direction perpendicular to the stacking direction corresponds to the diametrical direction. Therefore, hereinafter, the surface direction may also be referred to as the diametrical direction. The direction of the arrow B is an example of the diametrical direction.

Non-illustrated piping is connected to the end plate 20a. A non-illustrated back pressure mechanism is provided in this piping. The back pressure mechanism is capable of restricting the discharge of hydrogen from a later-described hydrogen passage 38c. The end plate 20a and the end plate 20b are fastened together via tie rods 22. In accordance with this feature, a clamping load acts on the plurality of the electrolysis cells 12.

A terminal portion 24a and a terminal portion 24b are provided respectively on side parts of the terminal plate 16a and the terminal plate 16b, in a manner so as to project outwardly in the diametrical direction. The terminal portion 24a and the terminal portion 24b are electrically connected, via a wiring 26a and a wiring 26b, to an electrical power source 28 used for carrying out electrolysis.

As shown in FIG. 2, each of the electrolysis cells 12 is equipped with a framed structural body 100A including a substantially disk-shaped membrane electrode assembly 30A, a first separator 32, and a second separator 34. The first separator 32 and the second separator 34 sandwich the framed structural body 100A therebetween. A cylindrical body 36 made of a resin is disposed between the first separator 32 and the second separator 34. The cylindrical body 36 surrounds the outer periphery of the membrane electrode assembly 30A. A gap between the first separator 32 and the cylindrical body 36 is sealed by a seal member 37a, and a gap between the cylindrical body 36 and the second separator 34 is sealed by a seal member 37b.

A fluid supply passage 38a is provided at one end in the diametrical direction (the direction of the arrow B) of the cylindrical body 36, and communicates mutually with the fluid supply passage 38a of another adjacent cylindrical body 36 in the stacking direction (the direction of the arrow A). A fluid supply unit 90 is connected to the fluid supply passage 38a. The fluid supply unit 90 (refer to FIG. 1) supplies water, which is a fluid, to the fluid supply passage 38a.

A fluid discharge passage 38b, which serves in order to discharge oxygen generated based on an electrode reaction and unreacted water, is provided at another end in the diametrical direction (the direction of the arrow B) of the cylindrical body 36. As shown in FIG. 1, a supply coupling 92a is connected to the cylindrical body 36 that is disposed at another end (the lowermost end) in the stacking direction. A fluid supply port 39a of the supply coupling 92a communicates with the fluid supply passage 38a shown in FIG. 2. As shown in FIG. 1, a discharge coupling 92b is connected to the cylindrical body 36 that is disposed at one end (the uppermost end) in the stacking direction. A fluid discharge port 39b of the discharge coupling 92b communicates with the fluid discharge passage 38b shown in FIG. 2.

As shown in FIG. 2, the electrolysis cells 12 include the hydrogen passage 38c that passes through the center in the diametrical direction along the stacking direction. Hydrogen that is generated by the electrolysis of water flows through the hydrogen passage 38c. The pressure of the hydrogen, for example, is compressed to 1 MPa to 80 MPa.

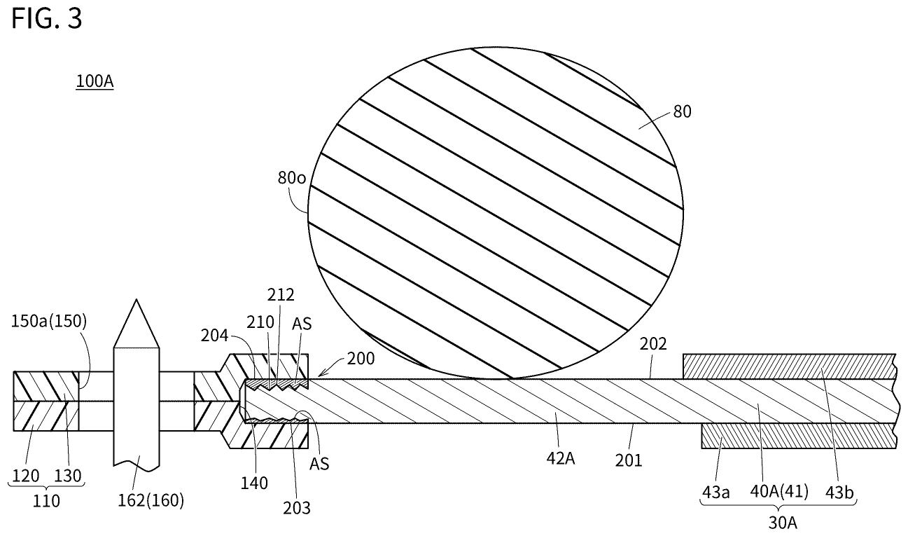

As shown in detail in FIG. 3, the framed structural body 100A includes a resin frame member 110, and the membrane electrode assembly 30A which is supported by the resin frame member 110. The resin frame member 110 has a degree of flexibility so as to be flexible as well as slightly stretchable. The membrane electrode assembly 30A includes the electrolyte membrane 40A, the first electrode 43a, and the second electrode 43b. The electrolyte membrane 40A, the first electrode 43a, and the second electrode 43b are sandwiched between a first current collector 44a and a second current collector 44b. Each of the electrolyte membrane 40A, the first electrode 43a, and the second electrode 43b, the first current collector 44a, and the second current collector 44b is substantially ring shaped. In the first embodiment, the electrolyte membrane 40A is formed from a single individual ion exchange membrane 41.

In the first embodiment, the outer diameter of the first electrode 43a and the outer diameter of the second electrode 43b are substantially equivalent. The outer diameter of the electrolyte membrane 40A is greater than each of the outer diameter of the first electrode 43a and the outer diameter of the second electrode 43b. Therefore, a peripheral edge portion 42A of the electrolyte membrane 40A is exposed outwardly more so than the peripheral portion of the first electrode 43a and the peripheral portion of the second electrode 43b. The resin frame member 110 is bonded to a membrane side bonding portion 200 of the electrolyte membrane 40A. The membrane side bonding portion 200 is one part of the peripheral edge portion 42A of the electrolyte membrane 40A, and forms the bonded portion between the electrolyte membrane 40A and the resin frame member 110.

The electrolyte membrane 40A includes a first surface 201 that faces toward the first electrode 43a, and a second surface 202 that faces toward the second electrode 43b. The membrane side bonding portion 200 includes a first bonding portion 203 formed on the first surface 201, and a second bonding portion 204 formed on the second surface 202. The first bonding portion 203 and the second bonding portion 204 exhibit an annular shape.

A large number of minute concave portions 210 and convex portions 212 are formed in the membrane side bonding portion 200. Therefore, in the electrolyte membrane 40A, a surface roughness of the membrane side bonding portion 200 is greater in comparison with that of other portions than the membrane side bonding portion 200. Further, a surface roughness of the second bonding portion 204 is greater in comparison with that of the first bonding portion 203.

The membrane side bonding portion 200 can be formed, for example, by carrying out a surface treatment on a portion (hereinafter, referred to as a “preliminary bonding portion”) that will become the membrane side bonding portion 200 in the electrolyte membrane 40A. One example of such a surface treatment is an alkali treatment. Specifically, the preliminary bonding portion that becomes the first bonding portion 203 is selectively immersed in a strong base such as NaOH, KOH, or Ca(OH)₂. In accordance therewith, the preliminary bonding portion is subjected to etching, and thereby the first bonding portion 203 is formed. Moreover, in order to neutralize the strong base that has remained in the first bonding portion 203, it is preferable to wash the first bonding portion 203 with a strong acid. As the strong acid, there may be exemplified H₂SO₄, HCl, and HNO₃.

Next, the preliminary bonding portion that will become the second bonding portion 204 is selectively immersed in the aforementioned strong base. The immersion time period at this time is set to be longer than the immersion time period at the time when the first bonding portion 203 is obtained. Thereafter, the second bonding portion 204 is washed with the strong acid as described previously. Consequently, the second bonding portion 204 whose surface roughness is greater in comparison with that of the first bonding portion 203 is obtained.

The first bonding portion 203 may be formed as a plurality of concentric annular portions. In this case, after a predetermined portion of the preliminary bonding portion has been masked with an annular shaped masking material, the aforementioned alkali treatment is carried out with respect to the first surface 201. Locations where the masking material is not provided are subjected to etching, and locations that were masked by the masking material are not subjected to etching. In accordance with this feature, a plurality of the second bonding portions 204 are formed respectively on the outer peripheral side of the masking material, and on the inner peripheral side of the masking material. In the same manner, it is also possible to form a plurality of concentrically shaped second bonding portions 204.

A relationship between the surface roughness of the first bonding portion 203 and the surface roughness of the second bonding portion 204 is not necessarily limited to the above-described aspect. For example, the surface roughness of the second bonding portion 204 may be substantially the same as that of the first bonding portion 203. Further, it is not essential that the surface roughness of the membrane side bonding portion 200 be greater than that of the other portions.

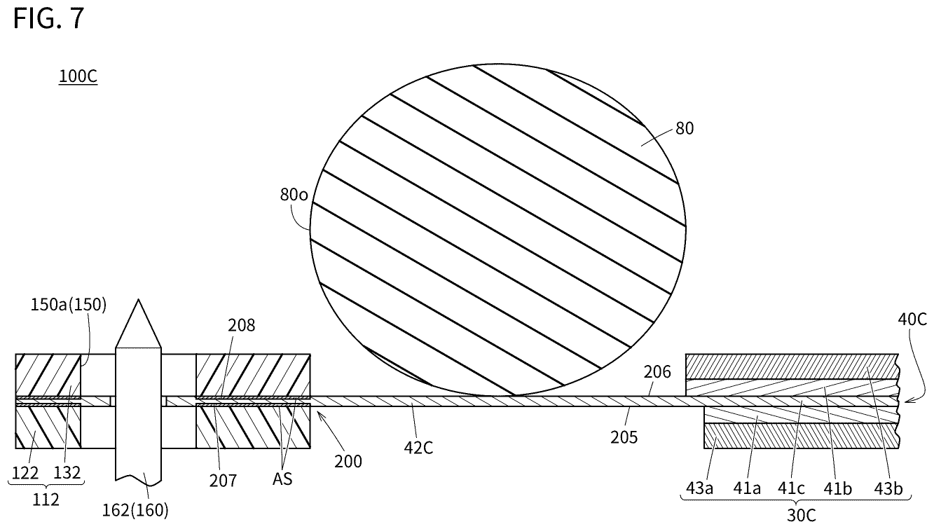

The resin frame member 110 includes a first member element 120 and a second member element 130. The first member element 120 and the second member element 130 are superimposed in the stacking direction. An annular shaped concave portion 140 is formed on an inner peripheral edge portion of the first member element 120 and the second member element 130 which are superimposed on each other. The membrane side bonding portion 200 of the electrolyte membrane 40A is inserted into the annular shaped concave portion 140. Alternatively, similar to FIG. 7, the membrane side bonding portion 200 may be sandwiched between a planar first member element 122 and a planar second member element 132.

The membrane side bonding portion 200 is bonded to the resin frame member 110, for example, via an adhesive AS. Specifically, in the first member element 120, the adhesive AS is interposed between a first inner surface forming the annular shaped concave portion 140, and the first bonding portion 203 that faces toward the first inner surface. Similarly, in the second member element 130, the adhesive AS is interposed between a second inner surface forming the annular shaped concave portion 140, and the second bonding portion 204 that faces toward the second inner surface. In the case that the surface roughness of the first bonding portion 203 and the second bonding portion 204 is greater in comparison with that of the other portions, then based on the anchor effect of the adhesive AS, the first inner surface and the first bonding portion 203 are firmly bonded together, and the second inner surface and the second bonding portion 204 are firmly bonded together.

As shown in FIG. 2, in the interior of each of the electrolysis cells 12, a space is formed that is surrounded by the first separator 32, the cylindrical body 36, and the electrolyte membrane 40A. This space serves as a first electrode chamber 45a. A flow path forming member 46 and the first current collector 44a are accommodated in the first electrode chamber 45a. The flow path forming member 46 and the first current collector 44a are interposed between the first separator 32 and the electrolyte membrane 40A. The flow path forming member 46, in the stacking direction, is sandwiched between the first separator 32 and the first current collector 44a.

The flow path forming member 46 includes an inlet protruding portion 46a and an outlet protruding portion 46b on the outer peripheral portion. The inlet protruding portion 46a and the outlet protruding portion 46b face toward each other in the diametrical direction.

A supply connection path 50a is formed in the inlet protruding portion 46a. The supply connection path 50a communicates with the fluid supply passage 38a and a fluid flow path 50b. A plurality of individual holes 50c communicate with the fluid flow path 50b. The holes 50c open toward the first current collector 44a. A discharge connection path 50d is formed in the outlet protruding portion 46b. The discharge connection path 50d communicates with the fluid flow path 50b and the fluid discharge passage 38b.

A protective sheet member 48 is disposed between the first current collector 44a and the first electrode 43a. The protective sheet member 48 includes a plurality of through holes 48a that extend in the stacking direction.

A substantially cylindrical shaped passage body 52 is disposed in the center in the diametrical direction between the first separator 32 and the electrolyte membrane 40A. The passage body 52 includes an inner cylindrical body 54 made from a porous body in which the hydrogen passage 38c is formed, and an outer cylindrical body 55 that surrounds the outer periphery of the inner cylindrical body 54. A gap between the inner cylindrical body 54 and the outer cylindrical body 55 is sealed by an O-ring 56a and an O-ring 56b.

In the outer peripheral portion of the outer cylindrical body 55, an annular stepped portion 55s is formed on an end surface thereof that faces toward the electrolyte membrane 40A. An inner peripheral portion of the protective sheet member 48 is inserted into the annular stepped portion 55s.

A space surrounded by the electrolyte membrane 40A, the cylindrical body 36, and the second separator 34 is a second electrode chamber 45b. The second current collector 44b and a load applying mechanism 58 are accommodated in the second electrode chamber 45b. In the stacking direction, the second current collector 44b and the load applying mechanism 58 are interposed between the electrolyte membrane 40A and the second separator 34.

The load applying mechanism 58, for example, includes a conductive elastic member such as a leaf spring 60 or the like. The leaf spring 60 applies a load to the second current collector 44b via a metallic shim member 62. The load is applied in a direction, namely, downwardly in the stacking direction, that presses the second current collector 44b toward the second electrode 43b.

A conductive sheet 66 is disposed between the second current collector 44b and the shim member 62. The conductive sheet 66 is formed, for example, from a metal sheet in which the hydrogen passage 38c is provided substantially in the center in the diametrical direction. The second current collector 44b includes a hole portion 67. An insulating sheet 68 is accommodated in the hole portion 67.

In the diametrical direction, a cylindrical member 70 is disposed inwardly of the load applying mechanism 58. The cylindrical member 70, in the stacking direction, is interposed between the conductive sheet 66 and the second separator 34. The hydrogen passage 38c is formed in the center in the diametrical direction of the cylindrical member 70. A hydrogen discharge path 71 is formed in one end surface of the cylindrical member 70 that faces toward the second separator 34. The hydrogen discharge path 71 communicates between the second electrode chamber 45b and the hydrogen passage 38c.

A seal member 80 and a pressure resistant member 84 are interposed in the stacking direction between the electrolyte membrane 40A and the second separator 34. In the diametrical direction, the pressure resistant member 84 is positioned on the outer periphery of the seal member 80.

Furthermore, the bonded portion by the adhesive AS between the resin frame member 110 and the membrane side bonding portion 200 is positioned more outwardly than an outer peripheral side end portion 800 of the seal member 80. However, the bonding location is not necessarily limited to being in this position. The position of the bonded portion may be more outwardly than the outer peripheral side end portion 800 of the seal member 80.

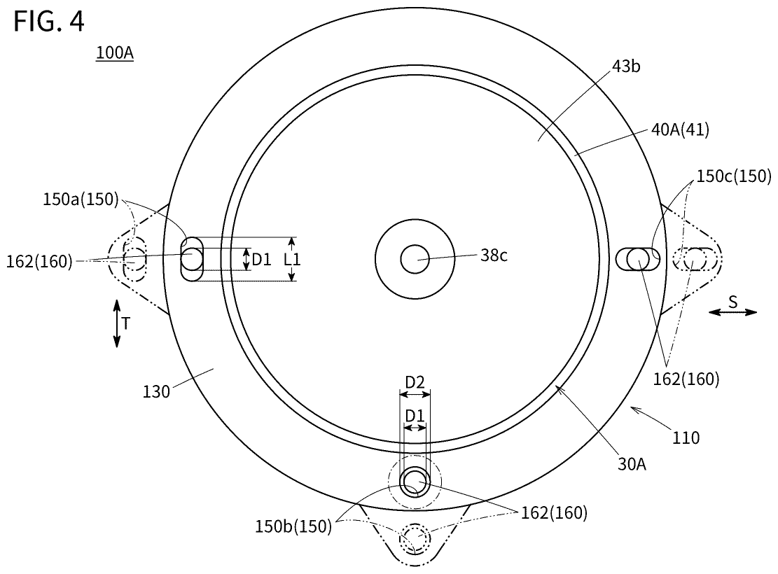

The electrolysis cells 12 include insertion holes 150 formed from the first current collector 44a to the second member element 130. In the example shown in FIG. 4, which is a cross-section taken along the direction of the arrow B, the insertion holes 150 include a first insertion hole 150a to a third insertion hole 150c aligned alongside one another in the circumferential direction. In the circumferential direction, the second insertion hole 150b is adjacent to the first insertion hole 150a, and the third insertion hole 150c is adjacent to the second insertion hole 150b. The distance between the first insertion hole 150a and the second insertion hole 150b is 90 degrees, and the distance between the second insertion hole 150b and the third insertion hole 150c is also 90 degrees. In contrast thereto, the distance between the third insertion hole 150c and the first insertion hole 150a is 180 degrees.

Positioning members 160 are inserted through the first insertion hole 150a to the third insertion hole 150c, respectively. In the first embodiment, the positioning members 160 are knock pins 162. In the illustrated example, lower ends of the knock pins 162 are supported by the flow path forming member 46. Upper ends of the knock pins 162 are inserted into positioning holes 164 that are formed in the pressure resistant member 84, and are thereby supported by the pressure resistant member 84. In this configuration, the flow path forming member 46 and the pressure resistant member 84 are a first member 166 and a second member 168, respectively, that serve to support the knock pins 162.

The first member 166 is not necessarily limited to being the flow path forming member 46. The first member 166 may be the first current collector 44a, or may be the protective sheet member 48. The second member 168 is not necessarily limited to being the pressure resistant member 84. The second member 168 may be the cylindrical body 36, or may be the first current collector 44a. Further, the knock pins 162, which are the positioning members 160, may be supported by either one of the first member 166 or the second member 168. It is not essential that the knock pins 162 be supported by both of the first member 166 and the second member 168.

In the example shown in FIG. 4, the first insertion hole 150a has an elongated hole shape that extends along the direction of the arrow T. The second insertion hole 150b has a substantially circular shape. The third insertion hole 150c has an elongated hole shape that extends along the direction of the arrow S. On the other hand, the cross-section of the knock pins 162 is a substantially circular shape. The cross-sectional area in the surface direction of the first insertion hole 150a to the third insertion hole 150c is greater in comparison with the cross-sectional area in the surface direction of the knock pins 162.

Specifically, the extension length L1 in the direction of the arrow T of the first insertion hole 150a is greater than the diameter D1 of the knock pin 162. Accordingly, with the resin frame member 110, movement in the direction of the arrow T in which the knock pin 162 and the first insertion hole 150a serve as a guide member is permitted. Similarly, with the resin frame member 110, movement in the direction of the arrow S in which the knock pin 162 and the third insertion hole 150c serve as a guide member is permitted. Furthermore, a diameter D2 of the second insertion hole 150b is greater than the diameter D1 of the knock pin 162. Therefore, with the resin frame member 110, movement thereof in the diametrical direction is permitted. In this manner, the knock pins 162, which are inserted through the first insertion hole 150a to the third insertion hole 150c, are permitted to move along the surface direction of the resin frame member 110.

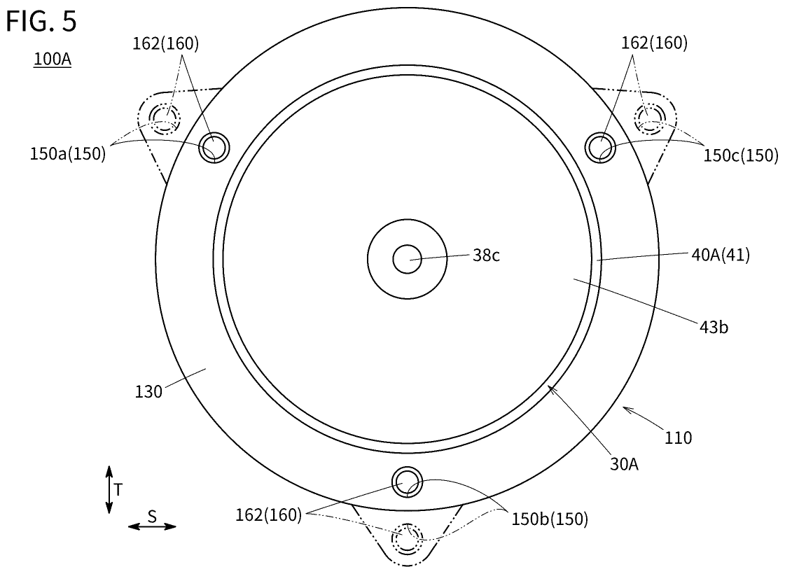

In the example shown in FIG. 5, the distance between the first insertion hole 150a and the second insertion hole 150b, the distance between the second insertion hole 150b and the third insertion hole 150c, and the distance between the third insertion hole 150c and the first insertion hole 150a are all 120 degrees. Further, the cross-section of each of the first insertion hole 150a to the third insertion hole 150c is substantially circular shaped. Although the cross-section of the knock pins 162 is also substantially circular, the diameter D2 of each of the first insertion hole 150a to the third insertion hole 150c is greater than the diameter D1 of the knock pin 162. Accordingly, due to this aspect, the cross-sectional area in the surface direction of the first insertion hole 150a to the third insertion hole 150c is greater in comparison with the cross-sectional area in the surface direction of the knock pins 162. Therefore, the knock pins 162, which are inserted through the first insertion hole 150a to the third insertion hole 150c, are permitted to move along the surface direction of the resin frame member 110.

The cross-sectional shape in the planar direction of the first insertion hole 150a to the third insertion hole 150c may be, for example, an elongated hole shape that extends along the diametrical direction. Further, in FIG. 4 and FIG. 5, although the insertion holes 150 are formed in the annular shaped portion of the resin frame member 110, the location where the insertion holes 150 are formed is not necessarily limited to being in the annular shaped portion of the resin frame member 110. For example, as shown by the phantom lines in FIG. 4 and FIG. 5, tab-shaped portions may be provided that project out along the diametrical direction from an outer peripheral edge portion of the annular portion of the resin frame member 110, and the insertion holes 150 may be formed in the tab-shaped portions.

As can be appreciated from the foregoing, the knock pins 162, which are the positioning members 160, in the surface direction, position the resin frame member 110 with respect to the flow path forming member 46 and the pressure resistant member 84. On the other hand, the knock pins 162 permit the resin frame member 110 to move along the surface direction.

Next, a description will be given concerning operations of the water electrolysis device 10.

A voltage is applied from the electrical power source 28 to the terminal portion 24a of the terminal plate 16a, and the terminal portion 24b of the terminal plate 16b shown in FIG. 1. Further, water is supplied as a fluid from a fluid supply unit 90. The water passes through the fluid supply port 39a, and flows into the fluid supply passage 38a (refer to FIG. 2) of the electrolysis cells 12. The water, inside each of the electrolysis cells 12, flows through the fluid supply passage 38a and the supply connection path 50a, and enters into the fluid flow path 50b of the flow path forming member 46. Thereafter, the water is supplied from the plurality of the holes 50c to the first current collector 44a.

The water is subject to electrolysis at the first electrode 43a. As a result, protons, electrons, and oxygen are generated. More specifically, the water is involved in an electrode reaction (an oxidation reaction) at the first electrode 43a. The protons are transferred through the electrolyte membrane 40A and to the second electrode 43b, where the protons combine with electrons. As a result, hydrogen is generated. The hydrogen passes through the pores of the second current collector 44b and the hydrogen discharge path 71, and is discharged from the second electrode chamber 45b into the hydrogen passage 38c.

Due to the aforementioned back pressure mechanism, discharging of the hydrogen from the hydrogen passage 38c is restricted. Therefore, accompanying the progression of the water electrolysis reaction in the electrolysis cells 12, the internal pressure of the second electrode chamber 45b rises due to the generated hydrogen. As a result, the internal pressure of the second electrode chamber 45b becomes higher than the internal pressure of the first electrode chamber 45a, and the hydrogen inside the hydrogen passage 38c is maintained at a high pressure. In accordance with this feature, it is possible to extract from the water electrolysis device 10 the high pressure hydrogen, which has risen to a predetermined pressure. On the other hand, the oxygen generated by the electrode reaction (the reduction reaction) at the first electrode 43a is entrained in the unreacted water, and is discharged at a normal pressure to the exterior of the water electrolysis device 10 via the fluid discharge passage 38b and the fluid discharge port 39b.

Accompanying the electrolysis reaction taking place, the electrolyte membrane 40A undergoes swelling. Further, the inner peripheral surface of the seal member 80 is pressed by the high pressure hydrogen inside the second electrode chamber 45b. Along therewith, the electrolyte membrane 40A is pulled by the lower surface of the seal member 80 which moves outwardly in the diametrical direction. Furthermore, the second surface 202 of the electrolyte membrane 40A receives the pressure from the high pressure hydrogen inside the second electrode chamber 45b. Due to the reasons described above, the electrolyte membrane 40A extends (diametrically expands) in the diametrical direction.

In the case that the resin frame member 110 is positioned and fixed in place, the extension outwardly in the diametrical direction of the electrolyte membrane 40A is prevented by the resin frame member 110. In this case, wrinkles may be generated in the peripheral edge portion 42A of the electrolyte membrane 40A. More specifically, deformation of the electrolyte membrane 40A can occur.

In contrast thereto, in the first embodiment, as shown in FIG. 4 and FIG. 5, the knock pins 162 are capable of moving along the diametrical direction within the insertion holes 150. Accordingly, when the electrolyte membrane 40A has expanded in diameter, the resin frame member 110 that supports the membrane electrode assembly 30A moves outwardly in the diametrical direction. Therefore, a situation is avoided in which the extension outwardly in the diametrical direction of the electrolyte membrane 40A is obstructed by the resin frame member 110. As a result, the generation of wrinkles in the peripheral edge portion 42A of the electrolyte membrane 40A is avoided. More specifically, it is possible to avoid a situation in which the electrolyte membrane 40A becomes deformed.

Further, at the bonded portion between the membrane side bonding portion 200 and the resin frame member 110, the membrane side bonding portion 200 and the resin frame member 110 are firmly bonded together based on the anchor effect of the adhesive AS. In addition, the bonded portion between the membrane side bonding portion 200 and the resin frame member 110 is positioned more outwardly than the outer peripheral side end portion 800 of the seal member 80. For this reason, it is not easy for the high pressure hydrogen to reach the bonded portion. Stated otherwise, it is difficult for the high pressure hydrogen to apply a pressure to the adhesive AS. Due to the reasons described above, a situation is avoided in which the membrane side bonding portion 200 peels off from the resin frame member 110. Therefore, the electrolyte membrane 40A and the resin frame member 110 are capable of moving together in an integrated manner.

Even in the case that the high pressure hydrogen has reached the bonded portion between the second bonding portion 204 and the second member element 130, since the surface roughness of the second bonding portion 204 is large, the anchor effect of the adhesive AS is also large. Accordingly, even in this case, it is difficult for the second bonding portion 204 to peel off from the second member element 130.

As noted previously, since deformation of the electrolyte membrane 40A is suppressed, an increase in the amount of the high pressure hydrogen generated at the second electrode 43b that permeates through the first electrode 43a is suppressed. Accordingly, a decrease in the amount of the hydrogen that is recovered via the hydrogen passage 38c is avoided. Further, since it is possible to avoid a situation in which the electrode reaction at the first electrode 43a is hindered by the hydrogen, a decrease in the reaction efficiency is avoided. For the reasons described above, the hydrogen and the oxygen can be obtained in a sufficient quantity by the electrolysis of water.

The first embodiment exhibits the following advantageous effects.

As shown in FIG. 2 and FIG. 3, the water electrolysis device 10 includes the resin frame member 110 which is bonded to the peripheral edge portion 42A of the electrolyte membrane 40A, the first member 166, the second member 168, and the knock pins 162 that serve as the positioning members 160. The knock pins 162 position the resin frame member 110 in the surface direction (the diametrical direction) perpendicular to the stacking direction with respect to the first member 166 or the second member 168. In accordance with such a configuration, the knock pins 162 permit the resin frame member 110 to move along the surface direction (the diametrical direction). Moreover, in the aspect shown in FIG. 2, the first member 166 serves as the flow path forming member 46, and the second member 168 serves as the pressure resistant member 84.

When the electrolyte membrane 40A undergoes swelling outwardly in the diametrical direction at the time of operation of the water electrolysis device 10, the resin frame member 110 moves outwardly in the diametrical direction. Similarly, when the electrolyte membrane 40A receives the pressure in the stacking direction by the high pressure hydrogen generated at the second electrode 43b, and thus extends diametrically outward, the resin frame member 110 moves outwardly in the diametrical direction.

As noted previously, in the above-described configuration, the electrolyte membrane 40A extends outwardly along the diametrical direction, and in accordance therewith, the resin frame member 110 moves outwardly in the diametrical direction. In accordance with this feature, a situation is avoided in which wrinkling (the occurrence of deformation) is generated in the electrolyte membrane 40A upon having received the pressure of the high pressure hydrogen.

As shown in FIG. 4 and FIG. 5, the resin frame member 110 includes the insertion holes 150 (the first insertion hole 150a to the third insertion hole 150c) through which the knock pins 162 are inserted. The cross-sectional area in the diametrical direction of the insertion holes 150 is greater in comparison with the cross-sectional area in the diametrical direction of the knock pins 162.

Therefore, the resin frame member 110 is capable of easily moving relative to the knock pins 162 in the diametrical direction.

As shown in FIG. 2, each of the electrolysis cells 12 includes the seal member 80 that surrounds the outer periphery of the second electrode 43b, and further, that is interposed between the resin frame member 110 and the second separator 34 in the stacking direction. The peripheral edge portion 42A of the electrolyte membrane 40A and the resin frame member 110 are bonded via the adhesive AS at the bonded portion. The bonded portion is positioned more outwardly than the outer peripheral side end portion 800 of the seal member 80.

Inwardly of the seal member 80, the high pressure hydrogen generated at the second electrode 43b is blocked by the seal member 80. Accordingly, a situation in which the high pressure hydrogen reaches the bonded portion is avoided. Therefore, a situation is also avoided in which the adhesive AS is pressed by the high pressure hydrogen. In accordance with this feature, a situation is avoided in which the electrolyte membrane 40A peels off from the resin frame member 110 due to the adhesive AS receiving the pressure of the gas.

The electrolyte membrane 40A includes the membrane side bonding portion 200 to which the resin frame member 110 is bonded via the adhesive AS. In the electrolyte membrane 40A, the surface roughness of the membrane side bonding portion 200 is greater than that of other portions than the membrane side bonding portion 200.

Because the surface roughness of the membrane side bonding portion 200 is large, the membrane side bonding portion 200 and the resin frame member 110 are firmly bonded together by the anchor effect of the adhesive AS. More specifically, any concern of the electrolyte membrane 40A peeling off from the resin frame member 110 is more effectively avoided.

The electrolyte membrane 40A includes the first surface 201 that faces toward the first electrode 43a, and the second surface 202 that faces toward the second electrode 43b. The membrane side bonding portion 200 includes the first bonding portion 203 formed on the first surface 201, and the second bonding portion 204 formed on the second surface 202. In accordance with such a configuration, the surface roughness of the second bonding portion 204 is greater in comparison with that of the first bonding portion 203.

In such a configuration, the anchor effect of the adhesive AS with respect the second surface 202 that faces toward the second electrode 43b is large. Therefore, the second surface 202 can be firmly bonded to the resin frame member 110. More specifically, any concern of the electrolyte membrane 40A peeling off from the resin frame member 110 is more effectively avoided. Furthermore, by the surface roughness of the first surface 201 being made smaller, it is possible to avoid a situation in which the thickness along the stacking direction in the membrane side bonding portion 200 becomes excessively small.

The above-described effect can be similarly obtained in the second embodiment to the fourth embodiment which will be described later.

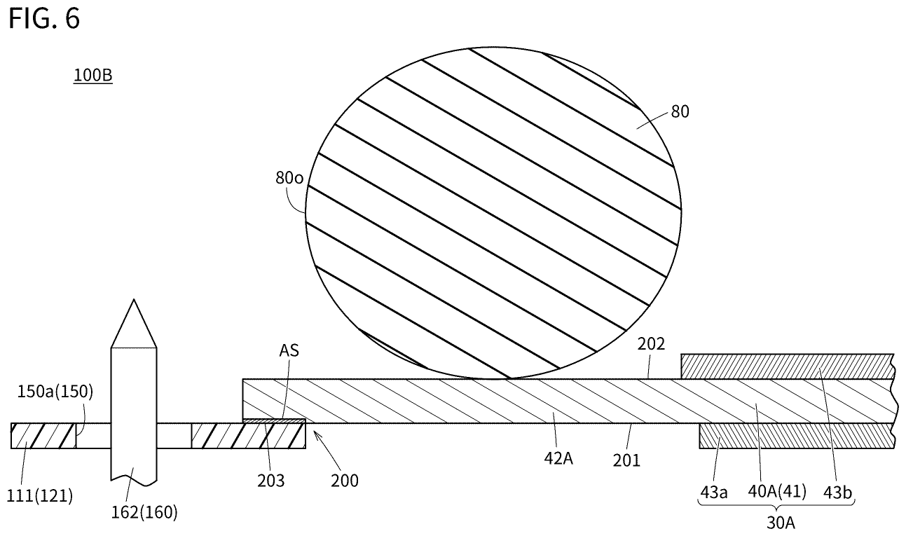

Next, with reference to FIG. 6, a description will be given concerning the second embodiment. Moreover, it should be noted that the same constituent elements as those shown in FIG. 1 to FIG. 5 are designated by the same reference numerals, and detailed description of such features will be omitted.

As shown in FIG. 6, in the second embodiment, each of the electrolysis cells 12 includes a framed structural body 100B. The framed structural body 100B includes the membrane electrode assembly 30A and a resin frame member 111. In the membrane electrode assembly 30A, the peripheral edge portion 42A of the electrolyte membrane 40A is exposed from the peripheral edge portion of the first electrode 43a and the peripheral edge portion of the second electrode 43b.

The electrolyte membrane 40A includes the first surface 201 that faces toward the first electrode 43a, and the second surface 202 that faces toward the second electrode 43b. In the aspect shown in FIG. 6, the membrane side bonding portion 200 is only the first bonding portion 203 that is formed on the first surface 201. Although not essential, in the same manner as in the first embodiment, it is preferable that the surface roughness of the first bonding portion 203 be made greater than that of portions other than the first bonding portion 203.

As shown in FIG. 6, in the second embodiment, the resin frame member 111 is formed from a single individual member element 121. In the aspect shown in FIG. 6, the resin frame member 111, in the stacking direction, is disposed downwardly of the electrolyte membrane 40A. In this state, in the inner edge portion of the resin frame member 111, the location that faces toward the first bonding portion 203 of the electrolyte membrane 40A is bonded via the adhesive AS to the first bonding portion 203. It is preferable that the bonded portion be positioned more outwardly than the outer peripheral side end portion 800 of the seal member 80.

In the present configuration, although it is difficult for the high pressure hydrogen that is generated at the second electrode 43b to reach the outer periphery of the seal member 80, even if the high pressure hydrogen does reach the outer periphery of the seal member 80, the adhesive AS on the second surface 202 will not be receive the pressure of the high pressure hydrogen. This is because there is no bonded portion that exists between the second surface 202 and the resin frame member 111.

However, contrary to the aspect shown in FIG. 6, the membrane side bonding portion 200 may be only the second bonding portion 204 (see FIG. 3) that is formed on the second surface 202. In such a configuration, the resin frame member 111 (the member element 121), in the stacking direction, is disposed upwardly of the electrolyte membrane 40A. Further, in the inner edge portion of the resin frame member 111, the location that faces toward the second bonding portion 204 of the electrolyte membrane 40A is bonded via the adhesive AS to the second bonding portion 204.

In this case as well, it is preferable that the bonded portion be positioned more outwardly than the outer peripheral side end portion 800 of the seal member 80. As noted previously, since it is difficult for the high pressure hydrogen generated at the second electrode 43b to reach the outer periphery of the seal member 80, a situation is avoided in which the adhesive AS receives the pressure of the high pressure hydrogen.

In the resin frame member 111, similar to FIG. 3 to FIG. 5, the insertion holes 150 (the first insertion hole 150a to the third insertion hole 150c) are formed more outwardly than the bonded portion. The knock pins 162 are inserted through the first insertion hole 150a to the third insertion hole 150c, respectively.

In the second embodiment, configurations thereof other than the above-described configuration are similar to those of the first embodiment. Further, concerning the operations of the water electrolysis device 10, the operations thereof are also similar to those of the first embodiment. Therefore, descriptions concerning the configurations and the operations other than those described above will be omitted.

The second embodiment exhibits the following advantageous effects.

The electrolyte membrane 40A includes the first surface 201 that faces toward the first electrode 43a, and the second surface 202 that faces toward the second electrode 43b, and the resin frame member 111 is bonded to only one of the first surface 201 (the first bonding portion 203), or alternatively, the second surface 202 (the second bonding portion 204).

As shown in FIG. 3, the resin frame member 110, which is simultaneously bonded to both the first surface 201 (the first bonding portion 203) and the second surface 202 (the second bonding portion 204), includes the first member element 120 that is bonded to the first surface 201, and the second member element 130 that is bonded to the second surface 202. In contrast thereto, in the second embodiment, it is possible to construct the resin frame member 111 using only either one of the member element 121 that is bonded to the first surface 201 (the first bonding portion 203), or alternatively, the member element 121 that is bonded to the second surface 202 (the second bonding portion 204). Accordingly, the number of the member elements 121 that constitute the resin frame member 111 can be reduced. Therefore, the configuration of the electrolysis cells 12 becomes simplified.

Next, with reference to FIG. 7, a description will be given concerning the third embodiment. Moreover, it should be noted that the same constituent elements as those shown in FIG. 1 to FIG. 6 are designated by the same reference numerals, and detailed description of such features will be omitted.

As shown in FIG. 7, in the third embodiment, each of the electrolysis cells 12 includes a framed structural body 100C. The framed structural body 100C includes a membrane electrode assembly 30C and a resin frame member 112. The membrane electrode assembly 30C includes an electrolyte membrane 40C, the first electrode 43a, and the second electrode 43b.

The electrolyte membrane 40C includes a first ion exchange membrane 41a, a second ion exchange membrane 41b, and a support membrane 41c. The first ion exchange membrane 41a is in contact with the first electrode 43a. The second ion exchange membrane 41b is in contact with the second electrode 43b. The support membrane 41c is interposed between the first ion exchange membrane 41a and the second ion exchange membrane 41b. Accordingly, the first ion exchange membrane 41a is interposed between the first electrode 43a and the support membrane 41c, and the second ion exchange membrane 41b is interposed between the support membrane 41c and the second electrode 43b.

The first ion exchange membrane 41a is a proton exchange membrane through which protons are capable of moving, and for example, is a hydrocarbon (HC)-based polymer membrane or a fluorine-based polymer membrane. The polymer that makes up the material of the first ion exchange membrane 41a includes a functional group involved in proton conduction. In the case of a fluorine-based polymer, the functional group is a sulfonic acid group.

The second ion exchange membrane 41b is made up from a similar material as that of the first ion exchange membrane 41a. In the second ion exchange membrane 41b, the concentration of the functional group involved in proton conduction may be equivalent to that in the first ion exchange membrane 41a; however, the concentration is preferably higher than that in the first ion exchange membrane 41a.

The support membrane 41c is more flexible and is more easily bent than the first ion exchange membrane 41a and the second ion exchange membrane 41b. Therefore, the support membrane 41c has a tensile strength that is greater than that in each of the first ion exchange membrane 41a and the second ion exchange membrane 41b. A suitable example of the material for the support membrane 41c is expanded polytetrafluoroethylene (ePTFE). However, the material of the support membrane 41c is not necessarily limited to being ePTFE.

The functional group that is moved respectively from the first ion exchange membrane 41a and the second ion exchange membrane 41b is bonded to the polymer that makes up the material of the support membrane 41c. Therefore, proton conduction also takes place in the support membrane 41c. In the case that the concentration of the functional group in the second ion exchange membrane 41b is higher in comparison with that in the first ion exchange membrane 41a, in the stacking direction, the concentration of the functional group in the support membrane 41c becomes decreased from the second ion exchange membrane 41b toward the first ion exchange membrane 41a. Stated otherwise, a concentration gradient of the functional group is formed in the support membrane 41c.

A peripheral edge portion 42C of the support membrane 41c is exposed externally from each of the peripheral edge portions of the first electrode 43a, the first ion exchange membrane 41a, the second ion exchange membrane 41b, and the second electrode 43b. A first surface 205 of the electrolyte membrane 40C, in the support membrane 41c, is a surface that faces toward the first electrode 43a and to which the first ion exchange membrane 41a is bonded. A second surface 206 in the electrolyte membrane 40C, in the support membrane 41c, is a surface that faces toward the second electrode 43b and to which the second ion exchange membrane 41b is bonded. The membrane side bonding portion 200 of the electrolyte membrane 40C is formed on the support membrane 41c. In the aspect shown in FIG. 7, the support membrane 41c includes a first bonding portion 207 formed on the first surface 205, and a second bonding portion 208 formed on the second surface 206. Although not essential, in the same manner as in the first embodiment, the surface roughness of the first bonding portion 207 may be made greater than that of portions other than the first bonding portion 207.

The resin frame member 112 includes the first member element 122 and the second member element 132. The first member element 122 is bonded, from the inner periphery to the outer periphery, via the adhesive AS to the first bonding portion 207 (the first surface 205). The second member element 132 is bonded, from the inner periphery to the outer periphery, via the adhesive AS to the second bonding portion 208 (the second surface 206). Alternatively, similar to FIG. 3, the annular shaped concave portion 140 may be formed on the inner peripheral edge portion of the first member element 122 and the second member element 132, and the peripheral edge portion 42C of the support membrane 41c may be inserted into the annular shaped concave portion 140.

In the third embodiment, a lower part of the seal member 80 abuts against the second surface 206 of the support membrane 41c. Moreover, the bonded portion of the resin frame member 112 to the support membrane 41c is positioned more outwardly than the outer peripheral side end portion 800 of the seal member 80. As noted previously, since it is difficult for the high pressure hydrogen generated at the second electrode 43b to reach the outer periphery of the seal member 80, a situation is avoided in which the adhesive AS of the second bonding portion 208 receives the pressure of the high pressure hydrogen.

A brief description will now be given concerning an example of a process for obtaining the electrolyte membrane 40C. Initially, the first electrode 43a is formed on one end surface of the first ion exchange membrane 41a. On the other hand, the second electrode 43b is formed on one end surface of the second ion exchange membrane 41b. Furthermore, the resin frame member 112 is bonded via the adhesive AS to the peripheral edge portion 42C of the support membrane 41c, which has a larger area than that of the first ion exchange membrane 41a and the second ion exchange membrane 41b.

Next, the support membrane 41c is laminated with respect to the other end surface of the first ion exchange membrane 41a. In the support membrane 41c, the surface that faces toward the other end surface of the first ion exchange membrane 41a is the first surface 205. Further, the other end surface of the second ion exchange membrane 41b is laminated with respect to the support membrane 41c. In the support membrane 41c, the surface that faces toward the other end surface of the second ion exchange membrane 41b is the second surface 206.

In the foregoing manner, a stacked body made up from the first electrode 43a, the first ion exchange membrane 41a, the support membrane 41c, the second ion exchange membrane 41b, and the second electrode 43b is obtained. Next, heat pressing is carried out with respect to the stacked body. Due to the heat pressing, each of the membranes from the first electrode 43a to the second electrode 43b are firmly bonded, and further, the first member element 122 and the second member element 132 are firmly bonded to the peripheral edge portion 42C of the support membrane 41c. Further, a portion of the functional group of the first ion exchange membrane 41a moves to the support membrane 41c, and further, a portion of the functional group of the second ion exchange membrane 41b moves to the support membrane 41c.

Alternatively, after the stacked body has been formed using the support membrane 41c to which the resin frame member 112 is not bonded, the resin frame member 112 may be bonded to the peripheral edge portion 42C of the support membrane 41c. Alternatively, after heat pressing has been carried out on the stacked body, the resin frame member 112 may be bonded to the peripheral edge portion 42C of the support membrane 41c.

In the resin frame member 112, similar to FIG. 3 to FIG. 5, the insertion holes 150 (the first insertion hole 150a to the third insertion hole 150c) are formed more outwardly than the bonded portion. The knock pin 162 is inserted through each of the first insertion hole 150a to the third insertion hole 150c.

In the third embodiment, configurations thereof other than the above-described configuration are similar to those of the first embodiment. Further, concerning the operations of the water electrolysis device 10, the operations thereof are also similar to those of the first embodiment. Therefore, descriptions concerning the configurations and the operations other than those described above will be omitted.

The third embodiment exhibits the following advantageous effects.

The electrolyte membrane 40C includes the first ion exchange membrane 41a in contact with the first electrode 43a, the second ion exchange membrane 41b in contact with the second electrode 43b, and the support membrane 41c interposed between the first ion exchange membrane 41a and the second ion exchange membrane 41b. The support membrane 41c has a greater tensile strength than that of each of the first ion exchange membrane 41a or the second ion exchange membrane 41b. The resin frame member 112 is bonded to the peripheral edge portion 42C of the support membrane 41c.

Because the tensile strength of the support membrane 41c is large, the deformation of the electrolyte membrane 40C due to the pressure of the high pressure hydrogen is further suppressed.

In one preferred aspect, the material of the support membrane 41c is ePTFE (expanded polytetrafluoroethylene) having a functional group. Moreover, the functional group is the same as the functional group involved in the ion exchange in the first ion exchange membrane 41a and the second ion exchange membrane 41b.

The ePTFE exhibits a superior tensile strength. In addition, in the third embodiment, the ePTFE includes a functional group involved in ion conduction. Therefore, via the electrolyte membrane 40C, ionic conduction takes place reliably between the first electrode 43a and the second electrode 43b.

In one preferred aspect, the concentration of the functional group in the second ion exchange membrane 41b is higher than that in the first ion exchange membrane 41a.

The second ion exchange membrane 41b contains moisture. In the second ion exchange membrane 41b, when the concentration of the functional group involved in ion exchange is high, it is possible to retain a large amount of the moisture. Accordingly, even in the case that the second ion exchange membrane 41b is pressed by the high pressure hydrogen, the second ion exchange membrane 41b retains a certain amount of the moisture. Therefore, even after the high pressure hydrogen has been generated at the second electrode 43b, sufficient ion conduction occurs in the second ion exchange membrane 41b.

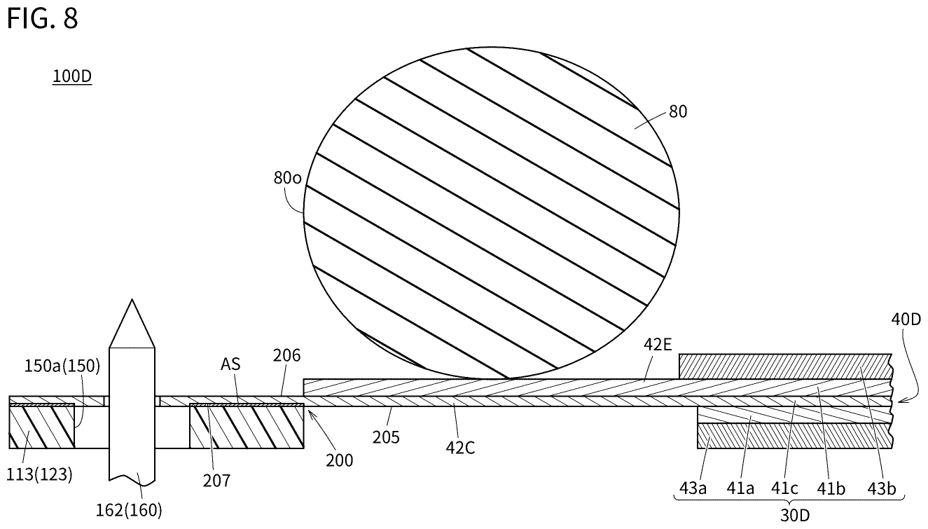

Next, with reference to FIG. 8, a description will be given concerning the fourth embodiment. Moreover, it should be noted that the same constituent elements as those shown in FIG. 1 to FIG. 7 are designated by the same reference numerals, and detailed description of such features will be omitted.

As shown in FIG. 8, in the fourth embodiment, each of the electrolysis cells 12 includes a framed structural body 100D. The framed structural body 100D includes a membrane electrode assembly 30D, and a resin frame member 113. The membrane electrode assembly 30D includes an electrolyte membrane 40D.

The electrolyte membrane 40D, in the same manner as the electrolyte membrane 40C, includes the first ion exchange membrane 41a, the second ion exchange membrane 41b, and the support membrane 41c. A suitable example of the material for the support membrane 41c, similar to the third embodiment, is ePTFE. In the fourth embodiment as well, it is preferable for the concentration of the functional group involved in proton conduction in the second ion exchange membrane 41b to be higher than that in the first ion exchange membrane 41a.

The area of the second ion exchange membrane 41b is larger than that of the first ion exchange membrane 41a, and is substantially equivalent to that of the support membrane 41c. Therefore, the peripheral edge portion 42C of the support membrane 41c and a peripheral edge portion 42E of the second ion exchange membrane 41b are exposed externally from each of the respective peripheral edge portions of the first electrode 43a, the first ion exchange membrane 41a, and the second electrode 43b.

The support membrane 41c that constitutes the electrolyte membrane 40D includes the first surface 205 that faces toward the first electrode 43a and the first ion exchange membrane 41a, and the second surface 206 that faces toward the second electrode 43b and the second ion exchange membrane 41b. In the aspect shown in FIG. 8, the membrane side bonding portion 200 is only the first bonding portion 207 that is formed on the first surface 205. Although not essential, in the same manner as in the first embodiment, it is preferable that the surface roughness of the first bonding portion 207 be made greater than that of portions other than the first bonding portion 207.

In the fourth embodiment, the resin frame member 113, in the same manner as in the second embodiment, is formed from a single individual member element 123. In the aspect shown in FIG. 8, the resin frame member 113, in the stacking direction, is disposed downwardly of the electrolyte membrane 40D. In this state, in the inner edge portion of the resin frame member 113, the location that faces toward the first bonding portion 207 of the electrolyte membrane 40D is bonded via the adhesive AS to the first bonding portion 207. It is preferable that the bonded portion be positioned more outwardly than the outer peripheral side end portion 800 of the seal member 80. Moreover, in the fourth embodiment, the lower part of the seal member 80 abuts against the upper surface of the peripheral edge portion 42E of the second ion exchange membrane 41b.

Contrary to the aspect shown in FIG. 8, the membrane side bonding portion 200 may be only the second bonding portion 208 (refer to FIG. 7) that is formed on the second surface 206 of the support membrane 41c. In such a configuration, the resin frame member 113, in the stacking direction, is disposed upwardly of the support membrane 41c. Further, in the inner edge portion of the resin frame member 113, the location that faces toward the second bonding portion 208 of the support membrane 41c is bonded via the adhesive AS to the second bonding portion 208. In this case as well, it is preferable that the bonded portion be positioned more outwardly than the outer peripheral side end portion 800 of the seal member 80.

Alternatively, in the same manner as shown in FIG. 7, the area of the first ion exchange membrane 41a may be approximately equivalent to that of the second ion exchange membrane 41b, and the peripheral edge portion 42C of the support membrane 41c may be exposed from the peripheral edge portions of the first electrode 43a, the first ion exchange membrane 41a, the second ion exchange membrane 41b, and the second electrode 43b. The lower part of the seal member 80 abuts against the second surface 206 of the peripheral edge portion 42C of the support membrane 41c.

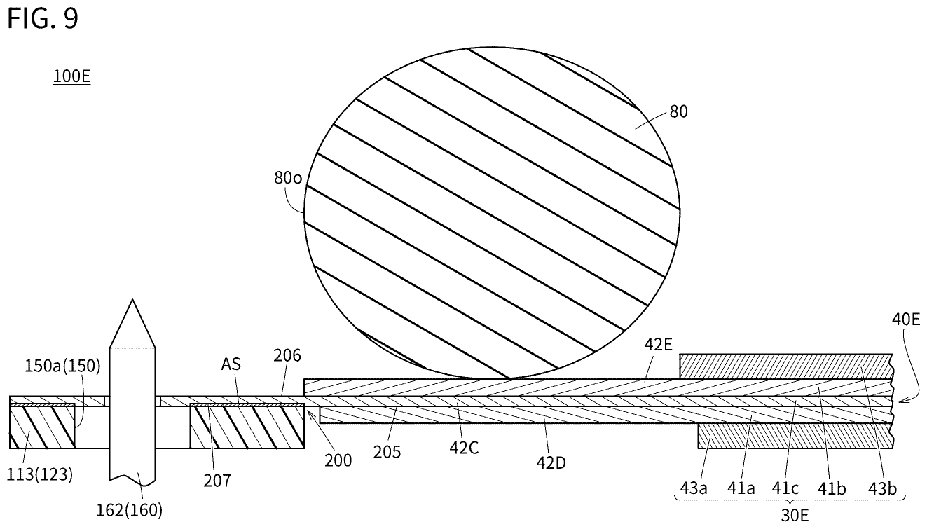

Alternatively, as in the first exemplary modification shown in FIG. 9, an electrolyte membrane 40E may be constituted in a manner so that the area of the first ion exchange membrane 41a is slightly smaller than the area of the second ion exchange membrane 41b. In this case, a membrane electrode assembly 30E having the electrolyte membrane 40E, and a framed structural body 100E having the membrane electrode assembly 30E are constituted.

The first ion exchange membrane 41a includes a peripheral edge portion 42D that is exposed from the respective peripheral edge portions of the first electrode 43a and the second electrode 43b. The peripheral edge portion 42D of the first ion exchange membrane 41a, the peripheral edge portion 42C of the support membrane 41c, and the peripheral edge portion 42E of the second ion exchange membrane 41b overlap one another in the stacking direction.

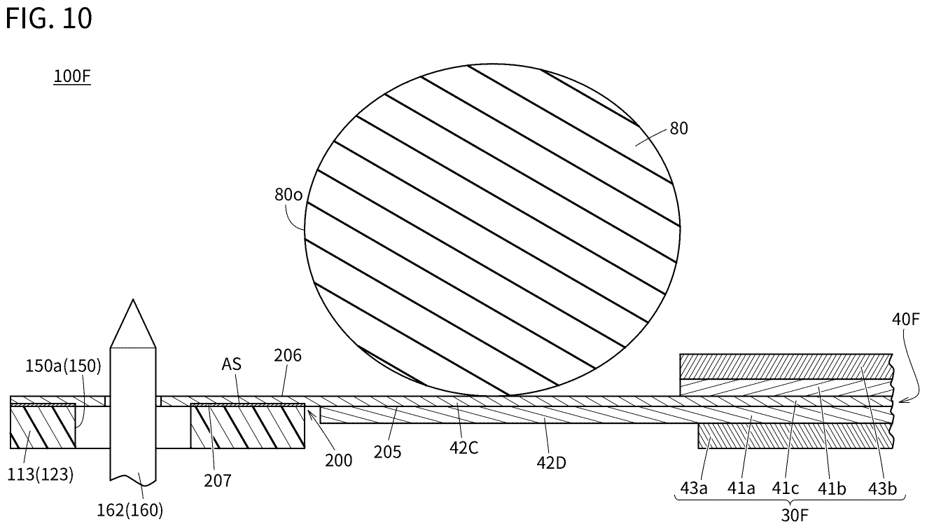

Alternatively, as in the second exemplary modification shown in FIG. 10, an electrolyte membrane 40F may be constituted in a manner so that the area of the first ion exchange membrane 41a is larger than the area of the second ion exchange membrane 41b and slightly smaller than the area of the support membrane 41c. In this case, a membrane electrode assembly 30F having the electrolyte membrane 40F, and a framed structural body 100F having the membrane electrode assembly 30F are constituted.

In this configuration, the peripheral edge portion 42D of the first ion exchange membrane 41a, and the peripheral edge portion 42C of the support membrane 41c overlap one another in the stacking direction. The lower part of the seal member 80 abuts against the second surface 206 of the peripheral edge portion 42C of the support membrane 41c.

Furthermore, the resin frame member 112 shown in FIG. 7 may be bonded to the electrolyte membrane 40E or the electrolyte membrane 40F.

In the resin frame member 113, similar to FIG. 3 to FIG. 5, the insertion holes 150 (the first insertion hole 150a to the third insertion hole 150c) are formed more outwardly than the bonded portion. The knock pins 162 are inserted through the first insertion hole 150a to the third insertion hole 150c, respectively.

In the fourth embodiment, configurations thereof other than the above-described configuration are similar to those of the first embodiment. Further, concerning the operations of the water electrolysis device 10, the operations thereof are also similar to those of the first embodiment. Therefore, descriptions concerning the configurations and the operations other than those described above will be omitted.

According to the fourth embodiment, similar to the electrolyte membrane 40C in the third embodiment, an effect is obtained in which the deformation of the electrolyte membrane 40D due to the pressure of the high pressure hydrogen is further suppressed. Further, in the fourth embodiment, it is possible to construct the resin frame member 113 using only either one of the member element 123 that is bonded to the first surface 205 (the first bonding portion 207), or alternatively, the member element 123 that is bonded to the second surface 206 (the second bonding portion 208). Accordingly, the number of the members that constitute the resin frame member 113 can be reduced. Therefore, the configuration of the water electrolysis device 10 becomes simplified.

In the above-described first embodiment to the fourth embodiment, an example is illustrated in which oxygen is generated as the first gas at the first electrode 43a, and hydrogen is generated as the second gas at the second electrode 43b. However, an aspect can also be cited in which the hydrogen is generated as the first gas at the first electrode 43a, and the oxygen is generated as the second gas at the second electrode 43b. A brief description will be given concerning this aspect. Moreover, similar to the aforementioned aspect, the electrolyte membranes 40A, 40C, and 40D are proton conductors.

In this aspect, the first electrode 43a serves as a cathode, and the second electrode 43b serves as an anode, and water is supplied to the first electrode 43a which is the cathode. The water permeates through the electrolyte membranes 40A, 40C, and 40D, and comes into contact with the second electrode 43b, which is the anode. At the second electrode 43b, by the water being subjected to electrolysis, protons, oxygen, and electrons are generated. The protons move through the electrolyte membranes 40A, 40C, and 40D to the first electrode 43a, which is the cathode. At the first electrode 43a, the protons and the electrons combine, and thereby generate hydrogen. The pressure of the oxygen rises to a predetermined pressure by the back pressure mechanism. More specifically, at the second electrode 43b, oxygen of a higher pressure than the hydrogen is obtained.

In the above-described first embodiment to the fourth embodiment, an aspect is exemplified in which the material of the electrolyte membranes 40A, 40C, and 40D is a proton conductor. However, the material of the electrolyte membranes 40A, 40C, and 40D may be an anion conductor. A brief description will be given concerning this aspect.

In the case that the electrolyte membranes 40A, 40C, and 40D, which are made of an anion conductive material, are used, and further, the first electrode 43a is used as the cathode and water is supplied to the first electrode 43a, at the first electrode 43a (the cathode), a reduction reaction occurs in which hydrogen and hydroxide ions are generated from the water. The hydroxide ions are conducted through the electrolyte membranes 40A, 40C, and 40D, and move to the second electrode 43b, which is the anode. At the second electrode 43b (the anode), an oxidation reaction occurs in which oxygen, water, and electrons are generated from the hydroxide ions. The pressure of the oxygen rises to a predetermined pressure by the back pressure mechanism. Stated otherwise, the oxygen, which is higher in pressure than the hydrogen, is obtained.

In contrast thereto, in the case that the first electrode 43a is used as the anode and water is supplied to the first electrode 43a, the water permeates through the electrolyte membranes 40A, 40C, and 40D, and comes into contact with the second electrode 43b, which is the cathode. At the second electrode 43b, a reduction reaction occurs in which hydrogen and hydroxide ions are generated from the water. The hydroxide ions are conducted through the electrolyte membranes 40A, 40C, and 40D, and move to the second electrode 43b, which is the cathode. At the second electrode 43b (the cathode), an oxidation reaction occurs in which oxygen, water, and electrons are generated from the hydroxide ions. The pressure of the hydrogen rises to a predetermined pressure by the back pressure mechanism. More specifically, the hydrogen, which is higher in pressure than the oxygen, is obtained.

Further, as described previously, the differential pressure electrolysis device 300 is not necessarily limited to being the water electrolysis device 10 that electrolyzes water. More specifically, the present invention can be applied to a differential pressure electrolysis device 300 that electrolyzes substances (fluids) other than water.

Concerning the above-described embodiments, the following supplementary notes are further disclosed.

### Supplementary Note 1

The differential pressure electrolysis device (300) according to the present embodiment is a differential pressure electrolysis device equipped with the electrolysis cell (12) including the membrane electrode assembly (30A, 30C, 30D) in which the electrolyte membrane (40A, 40C, 40D) is interposed between the first electrode (43a) and the second electrode (43b), and the first separator (32) and the second separator (34) configured to sandwich the membrane electrode assembly between the first separator and the second separator, wherein in the second electrode, the gas whose pressure is higher than the pressure of the gas obtained at the first electrode is obtained. The differential pressure electrolysis device is equipped with the resin frame member (110 to 113) bonded to the peripheral edge portion (42A, 42C) of the electrolyte membrane, the first member (166) interposed between the first separator and the resin frame member in the stacking direction of the first electrode, the electrolyte membrane, and the second electrode, the second member (168) interposed between the resin frame member and the second separator in the stacking direction, and the positioning member (160) configured to position the resin frame member with respect to the first member or the second member in the surface direction perpendicular to the stacking direction. The positioning member permits the resin frame member to move along the surface direction.

In this configuration, the resin frame member supports the electrolyte membrane. Further, when the electrolyte membrane is expanded along a surface direction perpendicular to the stacking direction at the time of operation of the differential pressure electrolysis device, the resin frame member is capable of moving along the surface direction. When the electrolyte membrane receives the pressure in the stacking direction due to the gas being generated in the second electrode, and extends along the surface direction, similarly, the resin frame member is capable of moving in the surface direction. As noted previously, in the case that the electrolyte membrane undergoes expansion along the surface direction, the resin frame member moves along the surface direction. In accordance with this feature, a situation is avoided in which wrinkles are generated (or the permanent deformation occurs) in the electrolyte membrane which has received the pressure of the gas.

### Supplementary Note 2

In the differential pressure electrolysis device according to Supplementary Note 1, the resin frame member may include the insertion hole (150) through which the positioning member is inserted, and the cross-sectional area of the insertion hole in the surface direction may be greater than the cross-sectional area of the positioning member in the surface direction.

In accordance with such a configuration, the resin frame member easily moves relative to the positioning member in the surface direction.

### Supplementary Note 3

In the differential pressure electrolysis device according to Supplementary Note 1 or 2, the electrolyte membrane may include the first surface (201, 205) that faces toward the first electrode, and the second surface (202, 206) that faces toward the second electrode, and the resin frame member may be bonded to only one of the first surface or the second surface.

Since the resin frame member is bonded to only one of the first surface or the second surface, the number of the individual resin frame members can be reduced. Therefore, the configuration can be brought about simply.

### Supplementary Note 4

In the differential pressure electrolysis device according to any one of Supplementary Notes 1 to 3, there may further be provided the seal member (80) configured to surround the outer periphery of the second electrode and which is interposed in the stacking direction between the resin frame member and the second separator, and the adhesive (AS) configured to bond the resin frame member and the peripheral edge portion of the electrolyte membrane, wherein the bonded portion between the resin frame member and the electrolyte membrane via the adhesive may be positioned more outwardly than the outer peripheral side end portion (800) of the seal member.

Inwardly of the seal member, a high pressure is brought about due to the gas generated at the second electrode. In contrast thereto, outwardly of the seal member, since the gas is blocked by the seal member, a situation is avoided in which a high pressure is brought about. According to the above-described configuration, a situation is avoided in which the bonding portion is positioned inwardly of the seal member where the high pressure is brought about. Therefore, a situation is avoided in which the electrolyte membrane peels off from the resin frame member due to the adhesive receiving the pressure of the gas.

### Supplementary Note 5

In the differential pressure electrolysis device according to any one of Supplementary Notes 1 to 4, there may further be provided the adhesive (AS) configured to bond the peripheral edge portion of the electrolyte membrane and the resin frame member, wherein the electrolyte membrane may include the membrane side bonding portion (200) to which the resin frame member is bonded via the adhesive, and in the electrolyte membrane, the surface roughness of the membrane side bonding portion may be greater than surface roughnesses of portions other than the membrane side bonding portion.

Because the surface roughness of the membrane side bonding portion is large, the membrane side bonding portion and the resin frame member are firmly bonded together by the anchor effect of the adhesive.

### Supplementary Note 6

In the differential pressure electrolysis device according to Supplementary Note 5, the electrolyte membrane may include the first surface (201, 205) that faces toward the first electrode, and the second surface (202, 206) that faces toward the second electrode, the membrane side bonding portion may include the first bonding portion (203, 207) formed on the first surface, and the second bonding portion (204, 208) formed on the second surface, and the surface roughness of the second bonding portion may be greater than the surface roughness of the first bonding portion.

On the second surface that faces toward the second electrode where the high pressure gas is generated, the adhesive brings about a large anchor effect. Therefore, the second surface can be firmly bonded to the resin frame member.

### Supplementary Note 7

In the differential pressure electrolysis device according to any one of Supplementary Notes 1 to 6, the electrolyte membrane may include the first ion exchange membrane (41a) in contact with the first electrode, the second ion exchange membrane (41b) in contact with the second electrode, and the support membrane (41c) interposed between the first ion exchange membrane and the second ion exchange membrane, and in which the tensile strength of support membrane is greater than the tensile strength of each of the first ion exchange membrane and the second ion exchange membrane, wherein the resin frame member may be bonded to the peripheral edge portion (42C) of the support membrane.

Since the tensile strength of the support membrane is large, deformation of the electrolyte membrane is further suppressed. Further, in comparison with the electrolyte membrane, it is difficult for the support membrane to receive an influence of the moisture. Stated otherwise, even in the case that the electrolyte membrane has come into contact with moisture, it is difficult for the support membrane to undergo swelling more so than the electrolyte membrane. Therefore, the embrittlement of the bonding of the electrolyte membrane by the adhesive to the resin frame member is suppressed. More specifically, any concern of the electrolyte membrane peeling off from the resin frame member is eliminated.

### Supplementary Note 8

In the differential pressure electrolysis device according to Supplementary Note 7, the material of the support membrane may be an expanded polytetrafluoroethylene having a functional group that is identical to a functional group involved in ion exchange in the first ion exchange membrane and the second ion exchange membrane.

In accordance with such a configuration, the ion conduction between the first electrode and the second electrode via the electrolyte membrane reliably takes place.

### Supplementary Note 9

In the differential pressure electrolysis device according to Supplementary Note 8, the concentration of the functional group of the second ion exchange membrane may be higher than the concentration of the functional group of the first ion exchange membrane.

The second ion exchange membrane contains moisture. In the second ion exchange membrane, when the concentration of the functional group involved in ion exchange is high, it is possible to retain a large amount of the moisture. Accordingly, even when the second ion exchange membrane is pressed by the high pressure gas, the second ion exchange membrane contains a certain amount of the moisture. Therefore, ion conduction takes place in the second ion exchange membrane.

Moreover, the present invention is not necessarily limited to the above-described disclosure, and various configurations can be adopted therein without departing from the essence and gist of the present invention.

1. A differential pressure electrolysis device equipped with an electrolysis cell including a membrane electrode assembly in which an electrolyte membrane is interposed between a first electrode and a second electrode, and a first separator and a second separator configured to sandwich the membrane electrode assembly between the first separator and the second separator, wherein in the second electrode, a gas whose pressure is higher than a pressure of a gas obtained at the first electrode is obtained, the differential pressure electrolysis device comprising:
a resin frame member bonded to a peripheral edge portion of the electrolyte membrane;
a first member interposed between the first separator and the resin frame member in a stacking direction of the first electrode, the electrolyte membrane, and the second electrode;
a second member interposed between the resin frame member and the second separator in the stacking direction; and
a positioning member configured to position the resin frame member with respect to the first member or the second member in a surface direction perpendicular to the stacking direction,
wherein the positioning member permits the resin frame member to move along the surface direction.

2. The differential pressure electrolysis device according to claim 1, wherein the resin frame member includes an insertion hole through which the positioning member is inserted, and a cross-sectional area of the insertion hole in the surface direction is greater than a cross-sectional area of the positioning member in the surface direction.

3. The differential pressure electrolysis device according to claim 1, wherein the electrolyte membrane includes a first surface that faces toward the first electrode, and
a second surface that faces toward the second electrode, and the resin frame member is bonded to only one of the first surface or the second surface.

4. The differential pressure electrolysis device according to claim 1, further comprising:
a seal member configured to surround an outer periphery of the second electrode and which is interposed in the stacking direction between the resin frame member and the second separator; and
an adhesive configured to bond the resin frame member and the peripheral edge portion of the electrolyte membrane,
wherein a bonded portion between the resin frame member and the electrolyte membrane via the adhesive is positioned more outwardly than an outer peripheral side end portion of the seal member.

5. The differential pressure electrolysis device according to claim 1, further comprising an adhesive configured to bond the peripheral edge portion of the electrolyte membrane and the resin frame member,
wherein the electrolyte membrane includes a membrane side bonding portion to which the resin frame member is bonded via the adhesive, and
in the electrolyte membrane, a surface roughness of the membrane side bonding portion is greater than surface roughnesses of portions other than the membrane side bonding portion.

6. The differential pressure electrolysis device according to claim 5, wherein:
the electrolyte membrane includes a first surface that faces toward the first electrode, and a second surface that faces toward the second electrode;
the membrane side bonding portion includes a first bonding portion formed on the first surface, and a second bonding portion formed on the second surface; and
a surface roughness of the second bonding portion is greater than a surface roughness of the first bonding portion.

7. The differential pressure electrolysis device according to claim 1, wherein the electrolyte membrane comprises:
a first ion exchange membrane in contact with the first electrode;
a second ion exchange membrane in contact with the second electrode; and
a support membrane interposed between the first ion exchange membrane and the second ion exchange membrane, and in which a tensile strength of the support membrane is greater than a tensile strength of each of the first ion exchange membrane and the second ion exchange membrane;
wherein the resin frame member is bonded to a peripheral edge portion of the support membrane.

8. The differential pressure electrolysis device according to claim 7, wherein a material of the support membrane is an expanded polytetrafluoroethylene having a functional group that is identical to a functional group involved in ion exchange in the first ion exchange membrane and the second ion exchange membrane.

9. The differential pressure electrolysis device according to claim 8, wherein a concentration of the functional group of the second ion exchange membrane is higher than a concentration of the functional group of the first ion exchange membrane.
